(19) United States
(12) Patent Application Publication
(10) Pub. No.: US 2023/0396979 A1
(43) Pub. Date: Dec. 7, 2023

(54) DUAL SUBSCRIBER IDENTITY MODULE (SIM) DUAL STANDBY (DSDS) FOR PROVIDING MULTI-SUBSCRIPTION COMMUNICATION SERVICES VIA MORE THAN ONE SIM

(71) Applicant: DISH Network L.L.C., Englewood, CO (US)

(72) Inventors: Kantha Kanchiraju, Overland Park, KS (US); Sougata Saha, Aurora, CO (US); Robert Urbanek, Overland Park, KS (US)

(73) Assignee: DISH Network L.L.C., Englewood, CO (US)

(21) Appl. No.: 18/174,216

(22) Filed: Feb. 24, 2023

Related U.S. Application Data
(60) Provisional application No. 63/421,119, filed on Oct. 31, 2022.
(60) Provisional application No. 63/349,479, filed on Jun. 6, 2022.

(51) Int. Cl. H04W 8/18

(52) U.S. Cl. CPC H04W 8/183; H04W 8/186

(57) ABSTRACT

Dual subscriber identity module (SIM) dual standby (DSDS) for providing multi-subscription communication services on more than one SIM via one or more respective radio access networks (RANs), one or more Wi-Fi networks, or a combination thereof, is disclosed. For instance, voice traffic and Internet Protocol (IP) multimedia subsystem (IMS) traffic may be handled on one SIM for one provider network and data traffic may be handled on another SIM for another provider network, if available. Icon(s) for only a single SIM and/or a single 5G network signal indicator may be shown on the UI of the UE.

### CROSS-REFERENCE TO RELATED APPLICATION(S)

This application claims the benefit of U.S. Provisional Patent Application Nos. 63/349,479 and 63/421,119 filed Jun. 6, 2022, and Oct. 31, 2022, respectively. The subject matter of these earlier filed applications is hereby incorporated by reference in its entirety.

### FIELD

The present invention generally relates to communications, and more specifically, to dual subscriber identity module (SIM) dual standby (DSDS) for providing multi-subscription communication services on more than one SIM.

### BACKGROUND

A SIM allows user equipment (UE), such as mobile devices, desktop computers with appropriate hardware, vehicle telecommunications systems, etc., to be identified and authenticated on a network. The UE is identified by the international mobile subscriber identity (IMSI) number associated with the SIM. The SIM identifies which service provider network that the UE connects with.

Network service providers may provide customers with a device with a preinstalled SIM for their network, or users may insert a SIM for the network into their own device. The SIM may also be associated a phone number for the device. A SIM may be a physical SIM (pSIM) or an embedded SIM (eSIM). A pSIM is a physical card that is inserted into an associated slot in the UE. An eSIM, on the other hand, is a digital version of a pSIM including a profile that can be downloaded to a mobile device to provide functionalities of a pSIM.

Currently, 5G devices with dual SIM support are available where UE can utilize a pair of SIMS, whether physical SIMs, eSIMs, or one of each. However, these SIMs are visible to the user as user interface (UI) options, which are not suitable for all desired scenarios. Accordingly, an improved and/or alternative approach may be beneficial.

### SUMMARY

Certain embodiments of the present invention may provide solutions to the problems and needs in the art that have not yet been fully identified, appreciated, or solved by current communication technologies, and/or provide a useful alternative thereto. For example, some embodiments of the present invention pertain to DSDS for providing multi-subscription communication services on more than one SIM.

In an embodiment, a non-transitory computer-readable medium of a DSDS-enabled device stores a computer program. The computer program is configured to cause at least one processor to detect that a carrier network associated with a secondary SIM is available and bind a framework associated with the secondary SIM to a carrier application that provides a carrier configuration service. The computer program is also configured to cause at least one processor to configure the secondary SIM via the carrier application. The configuration of the secondary SIM includes grouping subscriptions of a primary SIM and the secondary SIM and making the secondary SIM opportunistic.

In another embodiment, a computer-implemented method for providing DSDS includes detecting that a carrier network associated with a secondary SIM is available, by a DSDS device, and binding a framework associated with the secondary SIM to a carrier application that provides a carrier configuration service, by the DSDS device. The computer-implemented method also includes configuring the secondary SIM via the carrier application, by the DSDS device, and displaying a single SIM icon, a single network signal indicator, or both, for both a primary SIM and the secondary SIM, by the DSDS device. The computer-implemented method further includes preventing a user of the DSDS device from accessing settings pertaining to the secondary SIM, by the DSDS device.

In yet another embodiment, a computing system includes memory storing computer program instructions and at least one processor configured to execute the computer program instructions. The computer program instructions are configured to cause the at least one processor to detect that a carrier network associated with a secondary SIM is available and bind a framework associated with the secondary SIM to a carrier application that provides a carrier configuration service. The computer program instructions are also configured to cause the at least one processor to configure the secondary SIM via the carrier application. The computing system includes at least one additional SIM in addition to the primary SIM and the secondary SIM. The at least one additional SIM is not visible to a user via the computing system.

### BRIEF DESCRIPTION OF THE DRAWINGS

In order that the advantages of certain embodiments of the invention will be readily understood, a more particular description of the invention briefly described above will be rendered by reference to specific embodiments that are illustrated in the appended drawings. While it should be understood that these drawings depict only typical embodiments of the invention and are not therefore to be considered to be limiting of its scope, the invention will be described and explained with additional specificity and detail through the use of the accompanying drawings, in which:

FIG. 1 is an architectural diagram illustrating a pair of cellular service provider networks configured to implement DSDS, according to an embodiment of the present invention.

FIG. 2A illustrates a mobile device, according to an embodiment of the present invention.

FIG. 2B illustrates the mobile device of FIG. 2A with N SIMS notionally depicted, according to an embodiment of the present invention.

FIG. 3 is a flow diagram illustrating a process for triggering and carrying out functionality of a carrier application, according to an embodiment of the present invention.

FIG. 4 is a flow diagram illustrating a process for enabling DSDS, according to an embodiment of the present invention.

FIG. 5 is a flow diagram illustrating a process for enabling DSDS on a factory reset, according to an embodiment of the present invention.

FIG. 6 is a flow diagram illustrating a process for disabling and enabling an eSIM subscription in a DSDS system, according to an embodiment of the present invention.

FIG. 7 is a flowchart illustrating a process for managing a pSIM and an eSIM, according to an embodiment of the present invention.

FIG. 8A illustrates an example of a neural network that has been trained to improve a DSDS system, according to an embodiment of the present invention.

FIG. 8B illustrates an example of a neuron, according to an embodiment of the present invention.

FIG. 9 is a flowchart illustrating a process for training AI/ML model(s), according to an embodiment of the present invention.

FIG. 10 is an architectural diagram illustrating a computing system configured to perform respective functionality in a DSDS system, according to an embodiment of the present invention.

Unless otherwise indicated, similar reference characters denote corresponding features consistently throughout the attached drawings.

### DETAILED DESCRIPTION OF THE EMBODIMENTS

Some embodiments pertain to DSDS for providing multi-subscription communication services on more than one SIM via one or more respective radio access networks (RANs), one or more Wi-Fi networks, or a combination thereof. For instance, voice traffic and Internet Protocol (IP) multimedia subsystem (IMS) traffic may be handled on one SIM for one provider network and data traffic may be handled on another SIM for another provider network, if available. In certain embodiments, icon(s) for only a single SIM and/or a single 5G network signal indicator may be shown on the UI of the UE. Normal DSDS would show two of each. The download of an eSIM in the background as a secondary SIM, tertiary SIM, etc. and activation of the primary SIM along with the secondary SIM, tertiary SIM, etc. has not been done previously, and neither has the process of making the secondary SIM available, downloading the secondary SIM, and grouping the subscriptions.

In some embodiments, the presentation of multiple SIMS as a single SIM is accomplished via application programming interfaces (APIs) of the associated device (e.g., Android® APIs, iOS® APIs, etc.). The data subscription, for example, may be made opportunistic via these APIs. The subscription may be tied to the primary SIM subscription. Making the secondary subscription an opportunistic data subscription allows these features to be provided in the background. Indications that the device is roaming may also be removed.

Typically, the SIMS in a DSDS device share a single transceiver. Through time multiplexing, the radio connections for each SIM are maintained in idle mode. When the user receives a call on the network of a SIM handling voice traffic, it may not be possible to maintain a radio connection for a SIM handling data traffic in some embodiments. In such embodiments, the radio connection for data may be unavailable during the call. However, the registration to the provider network for data is maintained.

While on an active data session on the 5G network of the data provider, the DSDS device may remain in standby mode on the other provider network(s), continuing to listen to paging messages. Upon receiving a page from the non-data network(s), based on service settings, the UE automatically connects to the associated network while transitioning to standby on the data provider network in certain embodiments. In some embodiments, two or more SIM subscriptions may be leveraged to provide service to the user. For instance, in two SIM embodiments, a combination of pSIM+pSIM, pSIM+eSIM, or eSIM+eSIM may be used. However, some embodiments are not limited to two SIMs. Indeed, any number and/or combination of SIMS of any combination of pSIM(s) and eSIM(s) may be used without deviating from the scope of the invention. In certain embodiments, the existence of these additional SIMS may be hidden from the user (e.g., showing icon(s) for a single SIM, preventing display of SIM settings for the additional SIM(s), etc.).

In some embodiments, the subscriptions are grouped to appear as a single subscription to the user. In certain embodiments, the fact that multiple subscriptions are present on the UE is hidden from the user. Changes may be made to the UI, or the UI may be otherwise configured, to provide the impression that a single subscription is present.

In some embodiments, any capabilities of the UE allowing the user to view and/or configure multiple subscriptions are removed or hidden. In certain embodiments, one or more subscriptions are downloaded to the UE based on the presence of a primary subscription, and without user interaction and/or an interface for the user to view. The subscriptions may be grouped into a single subscription from the user's perspective and presented to the user as a single UE service (e.g., a phone service) and a single bill to the user.

In some embodiments, the UE is automatically configured to use the appropriate subscription for particular service(s) provided on the UE. In certain embodiments, when provisioning of a secondary or non-primary subscription fails, this event is reported to a provider server, cloud system, etc. A corresponding support ticket may be triggered to resolve the provisioning issue. Once the issue is resolved, the subscription may be downloaded again to the UE.

Various advantages may be provided by some or all embodiments. For instance, service providers may be able to make decisions with respect to picking the best network for a service that they offer based on different and/or desired parameters. Also, the user may be provided with the optimal service that is available based on the circumstances in some embodiments.

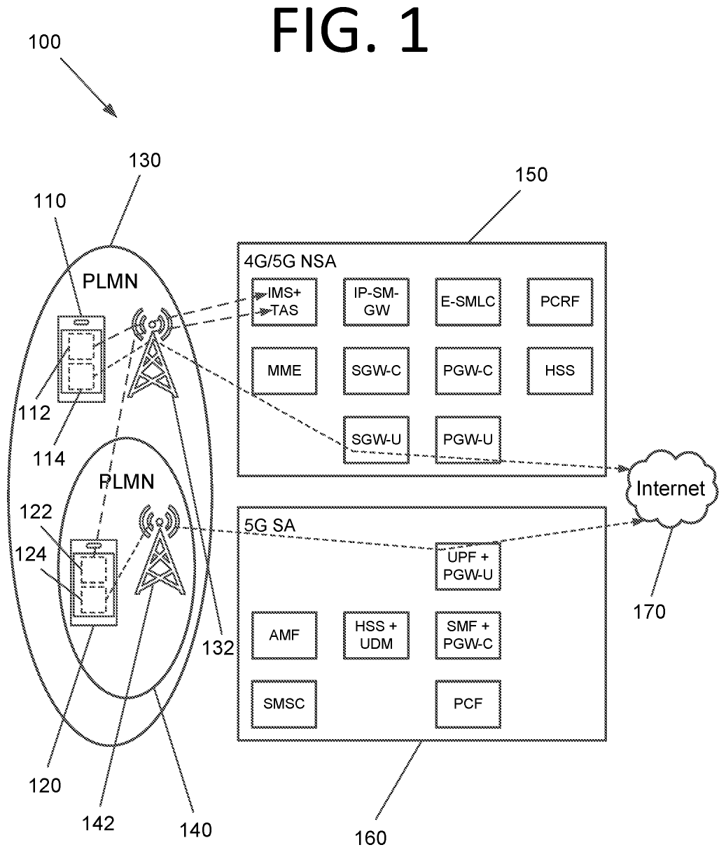

FIG. 1 is an architectural diagram 100 illustrating a pair of cellular service provider networks configured to implement DSDS, according to an embodiment of the present invention. A pair of DSDS devices 110, 120 are within the range of one or both of a pair of public land mobile networks (PLMNs) 130, 140, the coverage areas of which are provided by a pair of respective cell towers 132, 142. In some embodiments, one or both of DSDS devices 110, 120 may be computing system 1100 of FIG. 11. DSDS devices may include carrier applications in some embodiments. In certain embodiments, DSDS devices 110, 120 include one or more embedded universal integrated circuit cards (eUICCs) that act as hybrid hardware. The eUICC(s) allow over-the-air (OTA) provisioning of the eSIM profile from eSIMs 114, 124.

In some embodiments, PLMNs 130, 140 are RANs. In certain embodiments, DSDS devices 110, 120 may also send and receive data over other networks (not shown), such as a local area network (LAN), a wide area network (WAN), the Internet 170, or any combination thereof. PLMN 130 is associated with, and communicates with, a non-standalone (NSA) 4G or 5G carrier network 150, and PLMN 140 is associated with, and communicates with, a standalone (SA) 5G carrier network 160. NSA 150 and SA 160 are operably connected to the Internet 170.

NSA carrier network 150 provides IMS +telephone answering service (TAS) functionality, IP-SM Gateway (IP-SM-GW) functionality (the network functionality that provides the messaging service in the IMS network), enhanced serving mobile location center (E-SMLC) functionality, policy and charging rules function (PCRF) functionality, mobility management entity (MME) functionality, signaling gateway (SGW) control plane (SGW-C) and user data plane (SGW-U) ingress and egress point functionality, packet data network gateway (PGW) control plane (PGW-C) and user data plane (PGW-U) ingress and egress point functionality, and home subscriber server (HSS) functionality. SA carrier network 160 provides user plane function (UPF)+PGW-U functionality, access and mobility management (AMF) functionality, HSS+unified data management (UDM) functionality, session management function (SMF)+PGW-C functionality, short message service center (SMSC) functionality, and policy control function (PCF) functionality. It should be noted that additional and/or different network functionality may be provided without deviating from the present invention.

DSDS devices 110, 120 contain pSIMs 112, 122 and eSIMs 114, 124, respectively, in this embodiment. DSDS devices 110, 120 anchor on eSIMs 114, 124, respectively, and switch to pSIMs 112, 122 when a call is made or received. eSIMs 114, 124 act as data only devices, with cellular provider roaming. When in range of PLMN 140, as is the case with DSDS device 120, eSIM 124 provides data services via 5G SA carrier network 160. Outside of PLMN 140 but within PLMN 130, as is the case with DSDS device 110, eSIM 124 provides roaming data via 4G/5G NSA carrier network 150. pSIMs 112, 122 act like Mobile Virtual Network Operator (MVNO) devices of SA carrier network 160. pSIMs handle voice and IMS packets in this embodiment.

In some embodiments, during a call, DSDS devices 110, 120, handle both voice and data over pSIMs 112, 122, respectively. After the call ends, data switches back to eSIMs 114, 124. This may occur seamlessly, and without the knowledge of the user. Any connectivity loss by eSIMs 114, 124 may be protected by the pSIMs 112, 122 respectively. In other words, if a call is made or received, or if DSDS device 110, 120 move out of range of PLMN 140, voice and data capabilities are provided via pSIMs 112, 122, respectively.

In some embodiments, the UI of DSDS devices 110, 120 is identical to a single SIM device. pSIMs 112, 122 may trigger on provisioning of eSIMs 114, 124, respectively. No quick response (QR) code or user input is required in some embodiments.

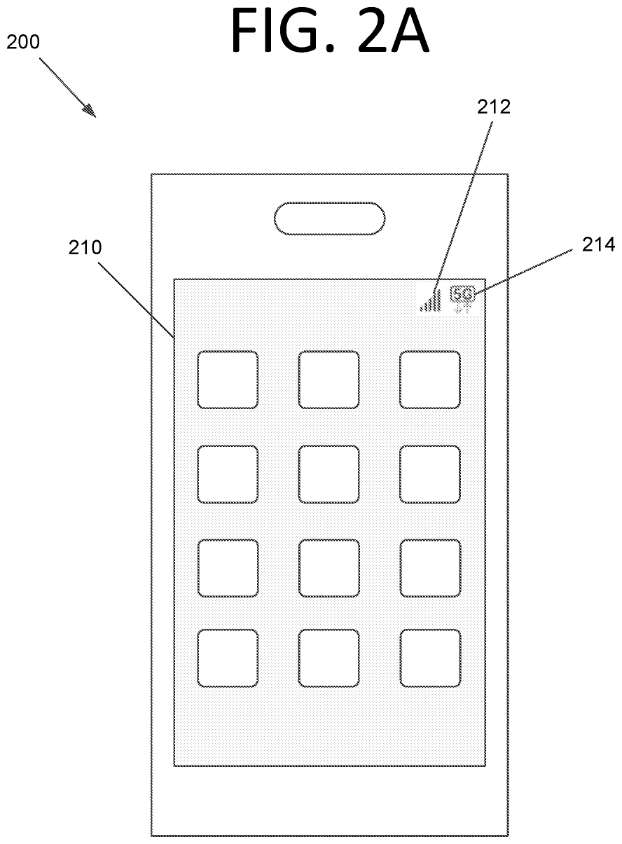

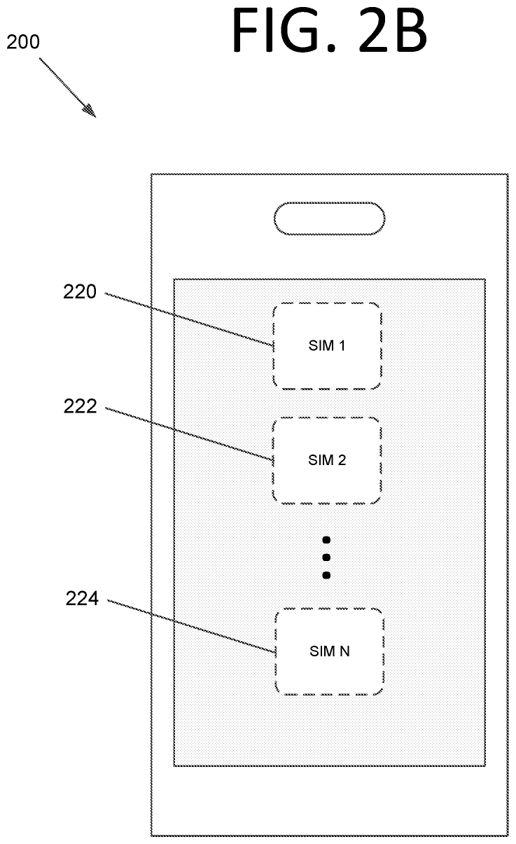

In some embodiments, a SIM card manager on UE may be hidden or otherwise unavailable to the user. Also, icon(s) for only a single SIM and/or a single network signal indicator may be shown on the UI of the UE. Such is the case with mobile device 200 of FIG. 2A. Mobile device 200 includes a UI 210 where only icons 212, 214 for a single SIM and a single 5G network signal indicator, respectively, are shown. In some embodiments, only one phone number is displayed across all settings menus, screens, voice applications, etc. of UI 210. Mobile device 200 has N SIMS in this embodiment (e.g., SIM 1 220, SIM 2 222, . . . , SIM N 224). See FIG. 2B.

In some embodiments, when a pSIM of a DSDS device is activated on an International Mobile Equipment Identity (IMEI), an eSIM of the DSDS device is provisioned with an eUICC Identifier (EID) of the DSDS device. When the pSIM is inserted into the appropriate slot of the DSDS device, a carrier application causes the DSDS device to reach out to a provider server to obtain an eSIM activation code. The carrier application communicates with an eUICC manager to download the eSIM profile (e.g., for Android® , using the downloadSubscription API of the eUICC manager). The eSIM will only be provisioned for data usage in some embodiments. In certain embodiments, when the pSIM is deactivated, the eSIM is also deactivated. As used herein, a “DSDS device” refers to UE or another suitable computing system that has DSDS capabilities.

In some embodiments, DSDS configuration for Android® may be performed as follows. The carrier application switches to the downloaded eSIM subscription using the switchToSubscription API. The carrier application makes the eSIM an opportunistic subscription using the setOpportunistic API. The carrier application groups the pSIM and eSIM into a single subscription using the createSubscriptionGroup API. This way, the eSIM is hidden from the user and only one active service is apparent to the user. However, it should be noted that any suitable device operating system may be used without deviating from the scope of the invention.

After the subscription grouping is complete, the carrier application makes the eSIM the default data subscription (DDS). This may be accomplished using the setPreferredOpportunisticDataSubscription API. The carrier application then sets the eSIM as the DDS on reboots and also on corresponding SIM events.

Per the above, in some embodiments, a carrier application handles the configuration and customization of the DSDS device based on the pSIM card inserted in the DSDS device. The carrier application may be signed with a certificate from the carrier and include the requisite privileges to control the SIMS.

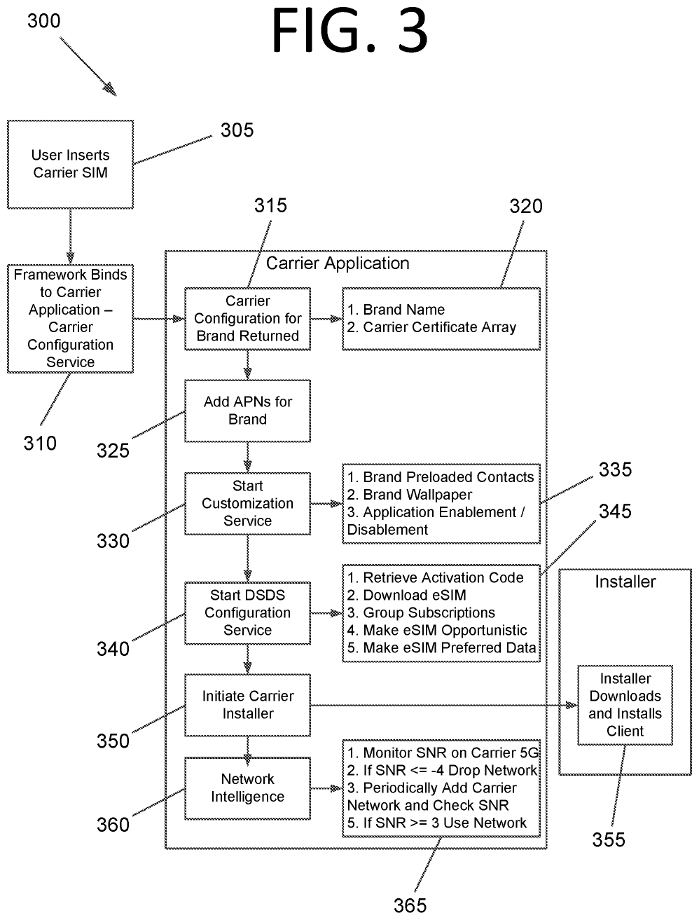

FIG. 3 is a flow diagram illustrating a process 300 for triggering and carrying out functionality of a carrier application, according to an embodiment of the present invention. The process begins with a user inserting a SIM card for a carrier into a DSDS device at 305. The device framework binds to the carrier application of the DSDS device at 310 via a carrier configuration service. The device framework binds to a service running within the carrier application in some embodiments. As used herein, “binding” refers to launching the carrier application and connecting to a service running within the carrier application. From that point onwards, the framework is able to invoke the APIs that are exposed by the service.

The carrier configuration for the brand is returned at 315, including the brand name and carrier certificate array 320. The access point names (APNs) for the brand are added at 325 and a customization service is started at 330. The customization service operations 335 include obtaining the brand preloaded contacts, the brand wallpaper, and the application enablement/disablement settings.

The DSDS configuration is then started at 340. The configuration operations 345 include retrieving an activation code, downloading an eSIM, grouping subscriptions, making the eSIM opportunistic, and making the eSIM preferred for data. The carrier installer is started at 350, and the installer downloads and installs a client at 355. Network intelligence 360 is then initiated. Network intelligence operations 365 include monitoring the signal-to-noise ratio (SNR) while on the carrier 5G network, dropping the carrier 5G network when the SNR is below a certain value (e.g., −4), on periodic intervals that may be fixed or intelligent (discussed in further detail later), adding the carrier network and checking the SNR, and when the SNR meets or exceeds a certain value (e.g., 3), using the carrier network.

In some embodiments, UE devices maintain a list of carrier networks (e.g., PLMNs) that are provided to the modem of the UE to scan and connect to. “Dropping” a carrier network or “adding” a carrier network in this context means that the carrier network is removed from or added to the list of carrier networks to scan, respectively. The list of allowed networks may be updated periodically to include a PLMN for a certain carrier in some embodiments. If the UE device finds this network and the signal strength threshold is met, the network is maintained in the list and used by the UE device. If not, the network is removed from the list, added again during the next check, and the process repeats.

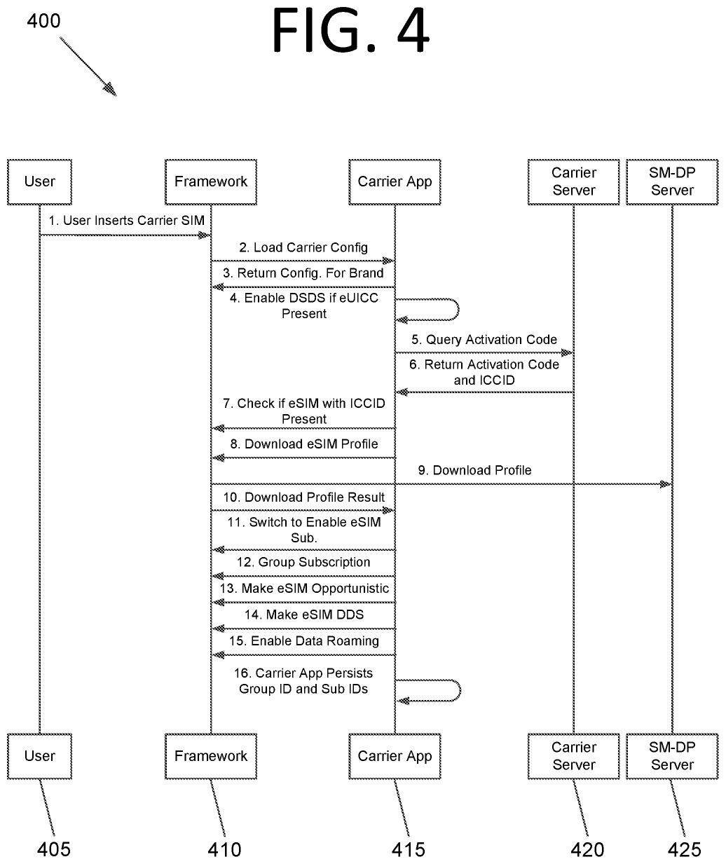

FIG. 4 is a flow diagram illustrating a process 400 for enabling DSDS, according to an embodiment of the present invention. The DSDS system includes a user 405, a framework 410 (here, the device operating system), a carrier application 415, a carrier server 420, and an SM-DP server 425. SM-DP server 425 stores and facilitates download of eSIM profiles. The process begins with the user inserting a SIM. In some embodiments, instead of insertion of a physical SIM card by a user, an eSIM may be downloaded to the device. After carrier application 415 recognizes the downloaded eSIM, the same process may be triggered.

The carrier configuration is loaded by the SIM/framework 410 to carrier application 415, which returns the configuration for the brand to framework 410. Carrier application 415 enables DSDS if an eUICC is present. Carrier application 415 also queries carrier server 420 to obtain the activation code and receives the activation code and integrated circuit card ID (ICCID) therefrom.

Carrier application 415 checks with framework 410 whether an eSIM with the ICCID is present, and if so, causes the eSIM profile to be downloaded from SM-DP server 425. The profile download result is downloaded from framework 410 by carrier application 415, and carrier application 415 causes framework 410 to switch to enable the eSIM subscription. Carrier application 415 also causes framework 410 to group subscriptions, make the eSIM opportunistic, make the eSIM DDS, and enable data roaming. Carrier application 415 then persists the group ID and subscriber IDs.

Carrier application 415 leverages APIs to perform various operations. For instance, for Android®, the carrier application may utilize the downloadSubscription, create Sub scriptionGroup, setOpportunistic, setPreferredOpportunisticDataSubscription, and semSetAllowDataDuringCall APIs. downloadSubscription enables downloading of the eSIM and groups the physical and eSIM subscriptions to present a single subscription to the user. The eSIM is made opportunistic via setOpportunistic so the eSIM is not visible to the user in the SIM Card Manager of the DSDS device. eSIM is made the default data subscription via setPreferredOpportunisticDataSubscription to leverage the eSIM carrier's 5G network. When there is a voice call, the DSDS device may use the pSIM for data. To enable this switch of data from eSIM to pSIM, semSetAllowDataDuringCall may be used.

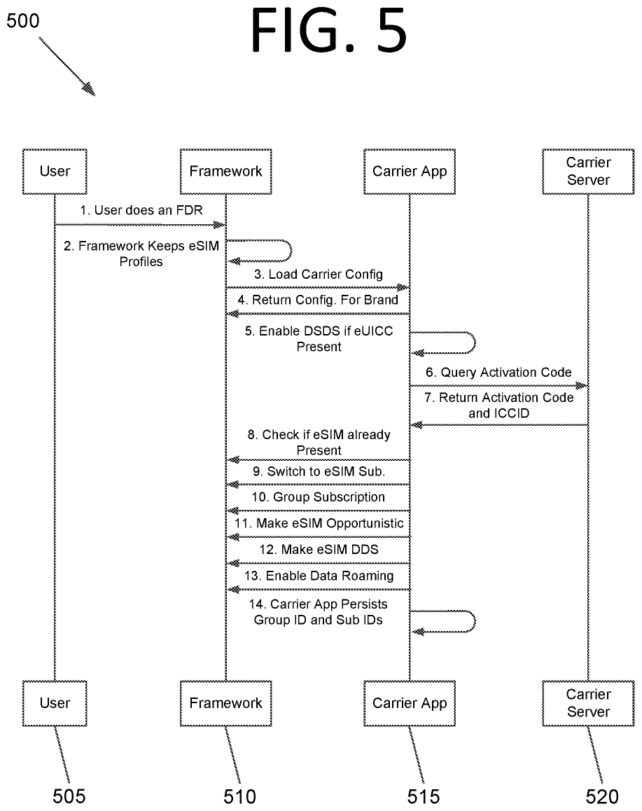

FIG. 5 is a flow diagram illustrating a process 500 for enabling DSDS on a factory reset, according to an embodiment of the present invention. Similar to FIG. 4, FIG. 5 includes a user 505, a framework 510, a carrier application 515, and a carrier server 520. When user 505 performs a factory data reset (FDR), framework 510 keeps the eSIM profiles, and the carrier configuration is loaded from framework 510 by carrier application 515. Carrier application 515 returns the configuration for the brand to framework 510 and enables DSDS if eUICC is present. Carrier application 515 also queries carrier server 520 to obtain the activation code and receives the activation code and integrated circuit card ID (ICCID) therefrom.

Carrier application 515 checks with framework 510 whether an eSIM with the ICCID is present, and if so, switches to the eSIM subscription. Carrier application 515 also causes framework 510 to group subscriptions, make the eSIM opportunistic, make the eSIM DDS, and enable data roaming. Carrier application 515 then persists the group ID and subscriber IDs.

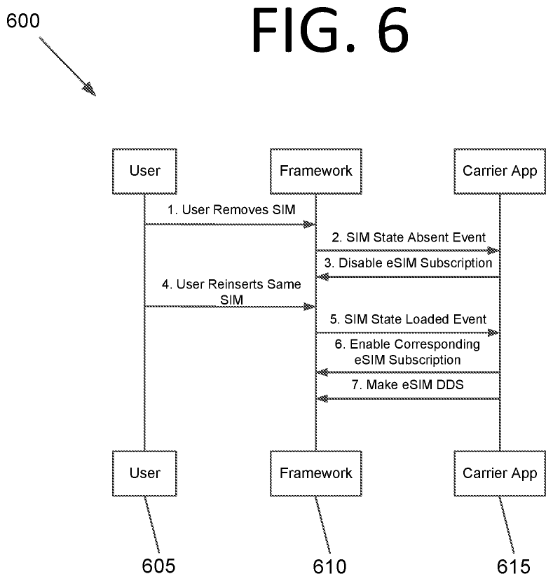

FIG. 6 is a flow diagram illustrating a process 600 for disabling and enabling an eSIM subscription in a DSDS system, according to an embodiment of the present invention. Similar to FIGS. 4 and 5, FIG. 6 includes a user 605, a framework 610, and a carrier application 615. When user 605 removes a data carrier pSIM, carrier application 615 attempts to hide the eSIM from user 605. When carrier application 615 detects a SIM state absent event with respect to the pSIM, carrier application 615 causes framework 610 to disable the eSIM subscription (e.g., using the switchToSubscription API for Android®). When user 605 re-inserts the same pSIM, carrier application 615 detects a SIM state loaded event and causes framework 610 to enable the corresponding eSIM subscription. Carrier application 615 also causes framework 610 to make the eSIM DDS. Since the eSIM is already opportunistic, it should not show up in the SIM Card Manager, and user 605 would thus not be able to interact with the eSIM.

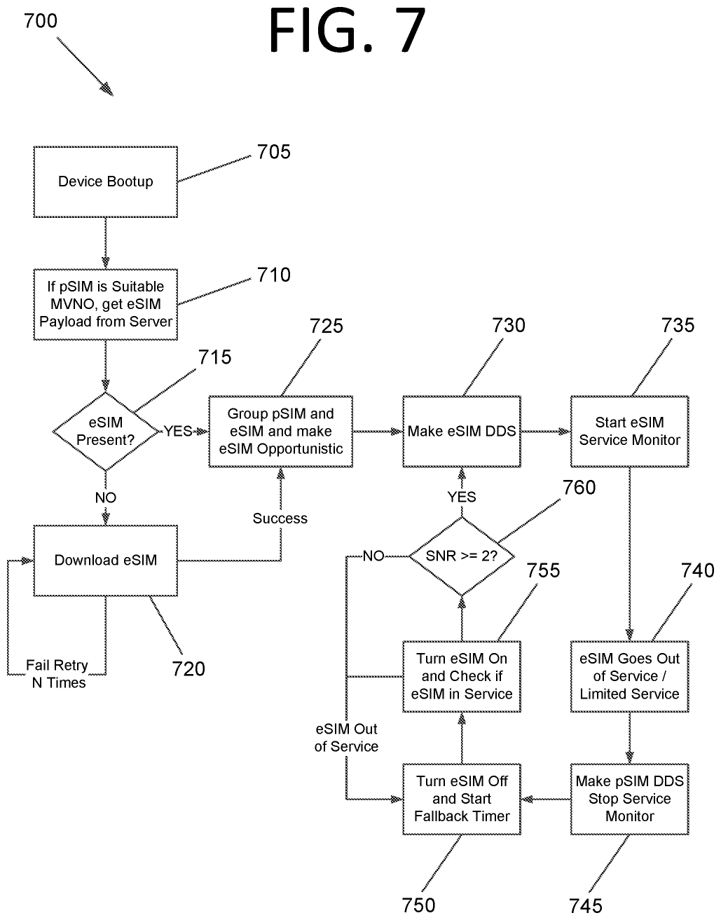

FIG. 7 is a flowchart illustrating a process 700 for managing a pSIM and an eSIM, according to an embodiment of the present invention. The process begins with performing bootup of a DSDS device at 705. If a pSIM is of a pertinent carrier, the eSIM payload is retrieved from a carrier server at 710. In this case, the eSIM payload is the data provided by the carrier server. The payload may include information such as the eSIM activation code and the associated ICCID.

If an eSIM is not present at 715, attempt(s) are made to download the eSIM at 720. If the eSIM was present at 720, or the eSIM is downloaded successfully at 715, the pSIM and eSIM are grouped and the eSIM is made opportunistic at 725. The eSIM is made DDS at 730 and a service monitor for the eSIM is started at 735. When the eSIM goes out of service or into an area of limited service at 740, the pSIM is made DDS and the service monitor is stopped at 745. The eSIM is turned off and a fallback timer or other periodic timing mechanism is started at 750. When the timer or other periodic mechanism expires or otherwise indicates that it is time to turn on the eSIM, the eSIM radio is turned on and a check is made whether the eSIM is in service at 755. If the eSIM SNR is sufficiently high (e.g., 2 or more) at 760, the eSIM is made DDS at 730. Otherwise, the process returns to step 750.

In some embodiments, if a user does not pay a bill for a subscription associated with a SIM, all SIMs are suspended. This makes the services collectively provided via all SIMs appear to the user as a single subscription or line of service. The subscriptions may be aggregated together and represented to the user under one bill. The user may have access to only one phone number associated with one subscription in some embodiments and may not be aware of the other numbers for other carriers.

Per the above, in some embodiments, the secondary SIM radio does not stay on when the secondary SIM is out of coverage. This prevents the secondary SIM from looking around constantly for a suitable network, which wastes battery and processing resources. In some embodiments, the timing of when the secondary SIM searches for a suitable network when out of coverage could be intelligent rather than based on a static timer. For instance, the timing could be tied to movement (e.g., an accelerometer or network-based intelligence where the distance the device moves and/or the device's location are used to determine the timing), a recursive timer where retries get further apart when they fail, based on a received signal from external equipment in the network, etc.

In certain embodiments, an IT-based rules engine may be used that knows what market the device is in and the events that are occurring in the area. For instance, a large sporting event such as the Super Bowl® may be occurring that makes congestion of the secondary SIM network so high that the network will not be able to provide data traffic. This information may be gleaned using artificial intelligence (AI), social calendars, the time of day, etc. AI may also be used to learn which subscriptions(s) are best for various services.

Per the above, while the pSIM may be used as a trigger for the eSIM, in some embodiments, it is possible to have two pSIMs, two eSIMs, three or more SIMS of any desired type(s) such that three or more subscriptions are supported, etc. In certain embodiments, two physical eUICCs may support a single SIM profile, and two or more embedded eUICC containers may be used, each with an eSIM. However, in certain embodiments, a physical eUICC container may have multiple eSIMs.

Standards support multiple enabled profiles, and generally speaking, an enabled profile is provided for each radio. However, it should be noted that other radio types may be provided in some embodiments. For instance, one or more profiles may be associated with Wi-Fi radios. A cellular SIM that handles voice and messaging may be provided as the primary SIM, a secondary cellular SIM may provide data, and a third SIM may provide radio for secure Wi-Fi. Secure Wi-Fi is when the carrier or a partner thereof has Wi-Fi deployments. These Wi-Fi access points allow devices with certain preloaded credentials to automatically connect thereto without requiring the user to manually configure the access point. The carrier application can download and configure the Wi-Fi credentials for the device in some embodiments similar to how the credentials are downloaded and configured for the eSIM.

In some embodiments, the eUICC does not necessarily represent a cellular identity. Rather, the eUICC may be a trusted environment for identity management for a digital credit card identity, digital keys, a bitcoin wallet, a key for access to home or a building, etc. stored on one card.

It is possible to have dual SIM, dual active with simultaneous radios. Secure Wi-Fi can use its own identity associated with that Wi-Fi radio, but dual SIM, dual active allows cellular implementation with more than one active radio. No current system has dual SIM, dual active functionality or control over which to use under which condition(s).

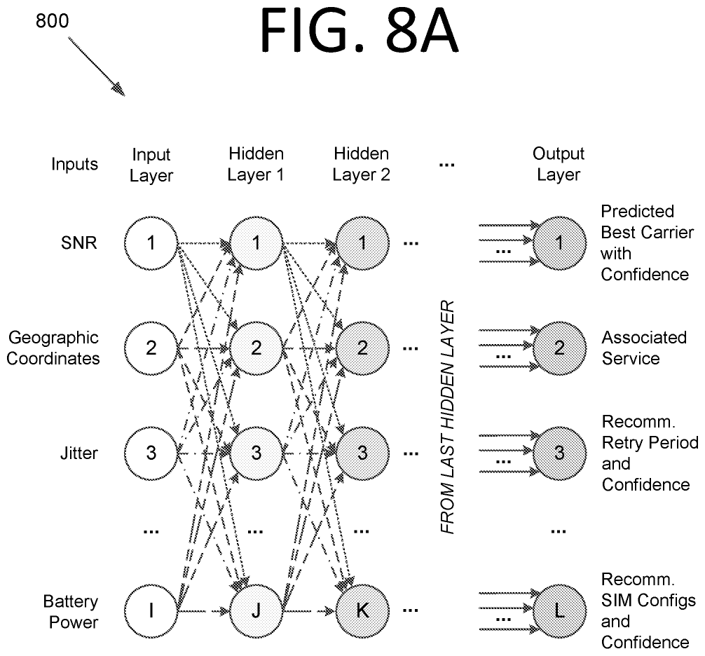

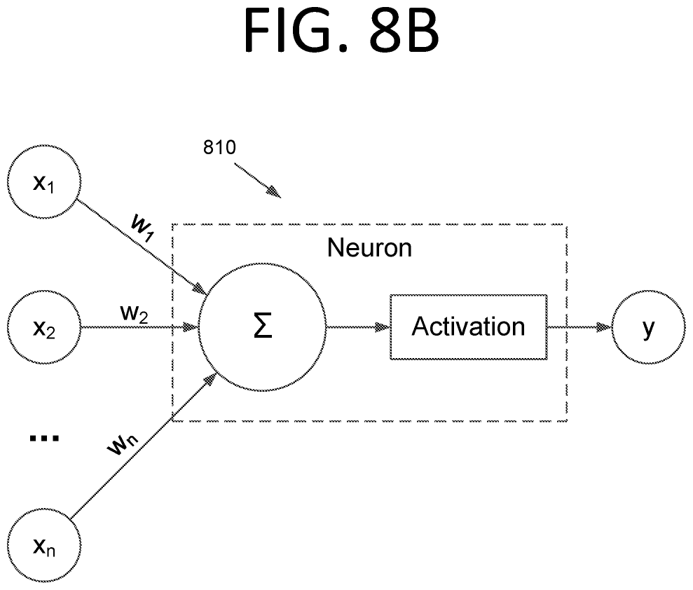

Per the above, AI/machine learning (ML) may be used to improve the DSDS system of some embodiments. Various types of AI/ML models may be trained and deployed without deviating from the scope of the invention. For instance, FIG. 8A illustrates an example of a neural network 800 that has been trained to suggest the best carrier for a service, a recommended retry period, recommended SIM configurations, etc., according to an embodiment of the present invention.

Neural network 800 also includes a number of hidden layers. Both DLNNs and shallow learning neural networks (SLNNs) usually have multiple layers, although SLNNs may only have one or two layers in some cases, and normally fewer than DLNNs. Typically, the neural network architecture includes an input layer, multiple intermediate layers, and an output layer, as is the case in neural network 800.

A DLNN often has many layers (e.g., 10, 50, 200, etc.) and subsequent layers typically reuse features from previous layers to compute more complex, general functions. A SLNN, on the other hand, tends to have only a few layers and train relatively quickly since expert features are created from raw data samples in advance. However, feature extraction is laborious. DLNNs, on the other hand, usually do not require expert features, but tend to take longer to train and have more layers.

For both approaches, the layers are trained simultaneously on the training set, normally checking for overfitting on an isolated cross-validation set. Both techniques can yield excellent results, and there is considerable enthusiasm for both approaches. The optimal size, shape, and quantity of individual layers varies depending on the problem that is addressed by the respective neural network.

Returning to FIG. 8A, SNR, geographic coordinates, jitter, battery power, etc. provided as the input layer are fed as inputs to the J neurons of hidden layer 1. While all of these inputs are fed to each neuron in this example, various architectures are possible that may be used individually or in combination including, but not limited to, feed forward networks, radial basis networks, deep feed forward networks, deep convolutional inverse graphics networks, convolutional neural networks, recurrent neural networks, artificial neural networks, long/short term memory networks, gated recurrent unit networks, generative adversarial networks, liquid state machines, auto encoders, variational auto encoders, denoising auto encoders, sparse auto encoders, extreme learning machines, echo state networks, Markov chains, Hopfield networks, Boltzmann machines, restricted Boltzmann machines, deep residual networks, Kohonen networks, deep belief networks, deep convolutional networks, support vector machines, neural Turing machines, or any other suitable type or combination of neural networks without deviating from the scope of the invention.

Hidden layer 2 receives inputs from hidden layer 1, hidden layer 3 receives inputs from hidden layer 2, and so on for all hidden layers until the last hidden layer provides its outputs as inputs for the output layer. It should be noted that numbers of neurons I, J, K, and L are not necessarily equal, and thus, any desired number of layers may be used for a given layer of neural network 800 without deviating from the scope of the invention. Indeed, in certain embodiments, the types of neurons in a given layer may not all be the same.

Neural network 800 is trained to assign a confidence score to appropriate outputs. In order to reduce predictions that are inaccurate, only those results with a confidence score that meets or exceeds a confidence threshold may be provided in some embodiments. For instance, if the confidence threshold is 80%, outputs with confidence scores exceeding this amount may be used and the rest may be ignored.

It should be noted that neural networks are probabilistic constructs that typically have confidence score(s). This may be a score learned by the AI/ML model based on how often a similar input was correctly identified during training. Some common types of confidence scores include a decimal number between 0 and 1 (which can be interpreted as a confidence percentage as well), a number between negative co and positive co, a set of expressions (e.g., “low,” “medium,” and “high”), etc. Various post-processing calibration techniques may also be employed in an attempt to obtain a more accurate confidence score, such as temperature scaling, batch normalization, weight decay, negative log likelihood (NLL), etc.

“Neurons” in a neural network are implemented algorithmically as mathematical functions that are typically based on the functioning of a biological neuron. Neurons receive weighted input and have a summation and an activation function that governs whether they pass output to the next layer. This activation function may be a nonlinear thresholded activity function where nothing happens if the value is below a threshold, but then the function linearly responds above the threshold (i.e., a rectified linear unit (ReLU) nonlinearity). Summation functions and ReLU functions are used in deep learning since real neurons can have approximately similar activity functions. Via linear transforms, information can be subtracted, added, etc. In essence, neurons act as gating functions that pass output to the next layer as governed by their underlying mathematical function. In some embodiments, different functions may be used for at least some neurons.

An example of a neuron 810 is shown in FIG. 8B. Inputs x₁, x₂, . . . , xₙ, from a preceding layer are assigned respective weights w₁, w₂, . . . , wₙ. Thus, the collective input from preceding neuron 1 is wᵢxᵢ. These weighted inputs are used for the neuron's summation function modified by a bias, such as:

$${\sum }_{i = 1}^{m} ( {w}_{i} {x}_{i} ) + bias \qquad ( 1 )$$

This summation is compared against an activation function f(x) to determine whether the neuron “fires”. For instance, f(x) may be given by:

$$f ( x ) = \{ \begin{matrix}1 if \sum wx + bias \geq 0 \\ 0 if \sum wx + bias < 0\end{matrix} \qquad ( 2 )$$

The output y of neuron 810 may thus be given by:

$$y = f ( x ) {\sum }_{i = 1}^{m} ( {w}_{i} {x}_{i} ) + bias \qquad ( 3 )$$

In this case, neuron 810 is a single-layer perceptron. However, any suitable neuron type or combination of neuron types may be used without deviating from the scope of the invention. It should also be noted that the ranges of values of the weights and/or the output value(s) of the activation function may differ in some embodiments without deviating from the scope of the invention.

The goal, or “reward function” is often employed, such as for this case the successful identification of graphical elements in the image. A reward function explores intermediate transitions and steps with both short-term and long-term rewards to guide the search of a state space and attempt to achieve a goal (e.g., finding the best carrier for a give service, determining a timing strategy for turning on a SIM radio in order to save power, determining when the network is likely to be congested, etc.).

During training, various labeled data is fed through neural network 800. Successful identifications strengthen weights for inputs to neurons, whereas unsuccessful identifications weaken them. A cost function, such as mean square error (MSE) or gradient descent may be used to punish predictions that are slightly wrong much less than predictions that are very wrong. If the performance of the AI/ML model is not improving after a certain number of training iterations, a data scientist may modify the reward function, provide corrections of incorrect predictions, etc.

Backpropagation is a technique for optimizing synaptic weights in a feedforward neural network. Backpropagation may be used to “pop the hood” on the hidden layers of the neural network to see how much of the loss every node is responsible for, and subsequently updating the weights in such a way that minimizes the loss by giving the nodes with higher error rates lower weights, and vice versa. In other words, backpropagation allows data scientists to repeatedly adjust the weights so as to minimize the difference between actual output and desired output.

The backpropagation algorithm is mathematically founded in optimization theory. In supervised learning, training data with a known output is passed through the neural network and error is computed with a cost function from known target output, which gives the error for backpropagation. Error is computed at the output, and this error is transformed into corrections for network weights that will minimize the error.

In the case of supervised learning, an example of backpropagation is provided below. A column vector input x is processed through a series of N nonlinear activity functions fᵢ between each layer i=1, . . . , N of the network, with the output at a given layer first multiplied by a synaptic matrix Wᵢ, and with a bias vector bᵢ added. The network output o, given by

o=f_{N}(W_{N}f_{N-1}(W_{N-1}f_{N-2}( . .. f₁(W₁x+b₁) . . . )+b_{N-1})+b_{N}) (4)

In some embodiments, o is compared with a target output t, resulting in an error

$$E = \frac{1}{2} {‖ o - t ‖}^{2} ,$$

which is desired to be minimized.

Optimization in the form of a gradient descent procedure may be used to minimize the error by modifying the synaptic weights Wᵢ for each layer. The gradient descent procedure requires the computation of the output o given an input x corresponding to a known target output t, and producing an error o−t. This global error is then propagated backwards giving local errors for weight updates with computations similar to, but not exactly the same as, those used for forward propagation. In particular, the backpropagation step typically requires an activity function of the form pⱼ(nⱼ)=fⱼ′(nⱼ), where nⱼ is the network activity at layer j (i.e., nⱼ=Wⱼoⱼ₋₁+bⱼ) where oⱼ=fⱼ(nⱼ) and the apostrophe ′ denotes the derivative of the activity function f.

The weight updates may be computed via the formulae:

$${d}_{j} = \{ \begin{matrix}( o - t ) ∘ {p}_{j} ( {n}_{j} ) , & j = N \\ {W}_{j + 1}^{T} {d}_{j + 1} ∘ {p}_{j} ( {n}_{j} ) , & j < N\end{matrix} \qquad ( 5 )$$

$$\frac{\partial E}{\partial {W}_{j + 1}} = {{d}_{j + 1} ( {o}_{j} )}^{T} \qquad ( 6 )$$

$$\frac{\partial E}{\partial {b}_{j + 1}} = {d}_{j + 1} \qquad ( 7 )$$

$${W}_{j}^{n e w} = {W}_{j}^{o l d} - η \frac{\partial E}{\partial {W}_{j}} \qquad ( 8 )$$

$${b}_{j}^{n e w} = {b}_{j}^{o l d} - η \frac{\partial E}{\partial {b}_{j}} \qquad ( 9 )$$

where ∘ denotes a Hadamard product (i.e., the element-wise product of two vectors), T denotes the matrix transpose, and oⱼ denotes fⱼ(Wⱼoⱼ₋₁+bⱼ), with o₀=x. Here, the learning rate η is chosen with respect to machine learning considerations. Below, η is related to the neural Hebbian learning mechanism used in the neural implementation. Note that the synapses W and b can be combined into one large synaptic matrix, where it is assumed that the input vector has appended ones, and extra columns representing the b synapses are subsumed to W.

The AI/ML model may be trained over multiple epochs until it reaches a good level of accuracy (e.g., 97% or better using an F2 or F4 threshold for detection and approximately 2,000 epochs). This accuracy level may be determined in some embodiments using an F1 score, an F2 score, an F4 score, or any other suitable technique without deviating from the scope of the invention. Once trained on the training data, the AI/ML model may be tested on a set of evaluation data that the AI/ML model has not encountered before. This helps to ensure that the AI/ML model is not “over fit” such that it performs well on the training data, but does not perform well on other data.

In some embodiments, it may not be known what accuracy level is possible for the AI/ML model to achieve. Accordingly, if the accuracy of the AI/ML model is starting to drop when analyzing the evaluation data (i.e., the model is performing well on the training data, but is starting to perform less well on the evaluation data), the AI/ML model may go through more epochs of training on the training data (and/or new training data). In some embodiments, the AI/ML model is only deployed if the accuracy reaches a certain level or if the accuracy of the trained AI/ML model is superior to an existing deployed AI/ML model. In certain embodiments, a collection of trained AI/ML models may be used to accomplish a task. This may collectively allow the AI/ML models to enable semantic understanding to better predict event-based congestion or service interruptions due to an accident, for instance.

Some embodiments may use transformer networks such as SentenceTransformers™, which is a Python™ framework for state-of-the-art sentence, text, and image embeddings. Such transformer networks learn associations of words and phrases that have both high scores and low scores. This trains the AI/ML model to determine what is close to the input and what is not, respectively. Rather than just using pairs of words/phrases, transformer networks may use the field length and field type, as well.

Natural language processing (NLP) techniques such as word2vec, BERT, GPT-3, etc. may be used in some embodiments to facilitate semantic understanding. Other techniques, such as clustering algorithms, may be used to find similarities between groups of elements. Clustering algorithms may include, but are not limited to, density-based algorithms, distribution-based algorithms, centroid-based algorithms, hierarchy-based algorithms. K-means clustering algorithms, the DB SCAN clustering algorithm, the Gaussian mixture model (GMM) algorithms, the balance iterative reducing and clustering using hierarchies (BIRCH) algorithm, etc. Such techniques may also assist with categorization.

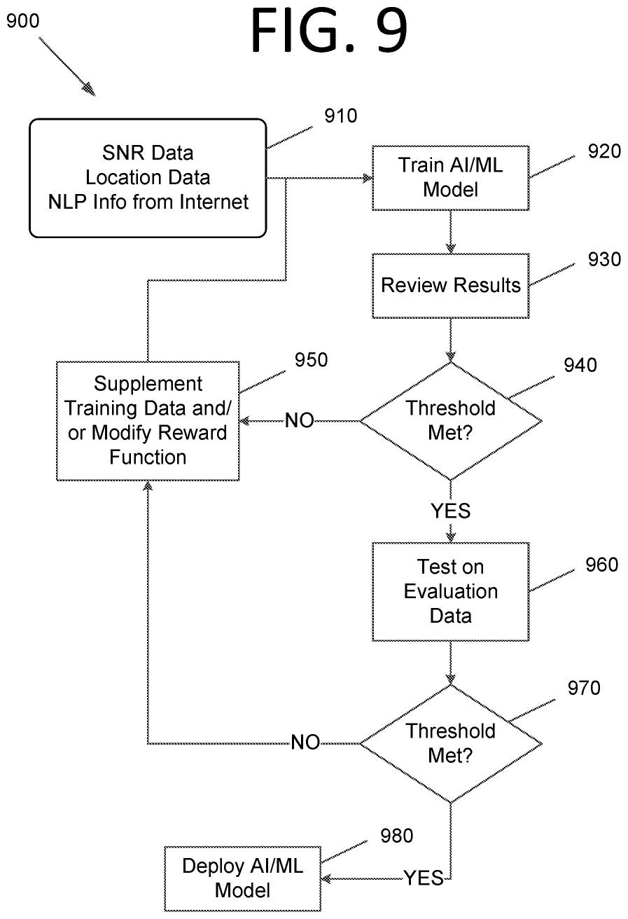

FIG. 9 is a flowchart illustrating a process 900 for training AI/ML model(s), according to an embodiment of the present invention. The process begins with providing training data, such as SNR data, location data, NLP information from the Internet, words and phrases, a “thesaurus” of semantic associations between words and phrases such that similar words and phrases for a given word or phrase can be identified, etc. at 910, whether labeled or unlabeled. Other training data used in addition to or in lieu of the training data shown in FIG. 9 may include, but is not limited to, available networks at the location, customer rate plans that determine the quality of service and thus impact the network that is selected, etc. Indeed, the nature of the training data that is provided will depend on the objective that the AI/ML model is intended to achieve. The AI/ML model is then trained over multiple epochs at 920 and results are reviewed at 930.

If the AI/ML model fails to meet a desired confidence threshold at 940, the training data is supplemented and/or the reward function is modified to help the AI/ML model achieve its objectives better at 950 and the process returns to step 920. If the AI/ML model meets the confidence threshold at 940, the AI/ML model is tested on evaluation data at 960 to ensure that the AI/ML model generalizes well and that the AI/ML model is not over fit with respect to the training data. The evaluation data includes information that the AI/ML model has not processed before. If the confidence threshold is met at 970 for the evaluation data, the AI/ML model is deployed at 980. If not, the process returns to step 950 and the AI/ML model is trained further.

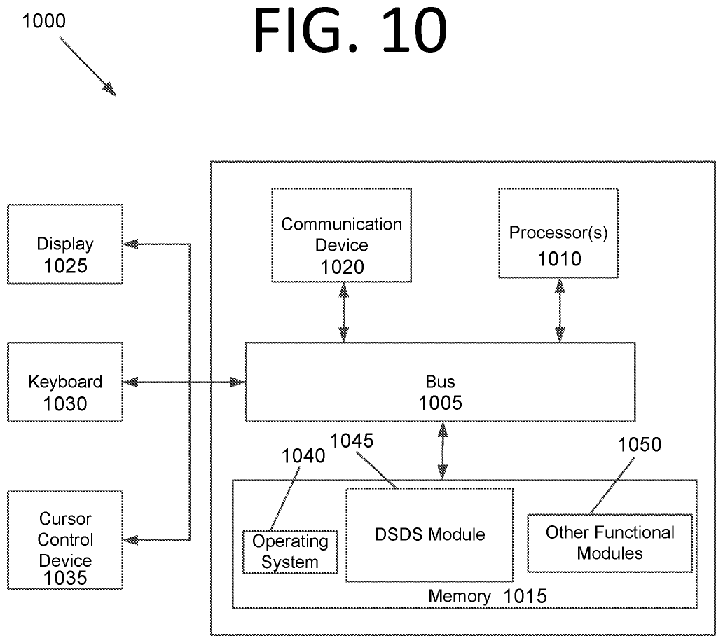

FIG. 10 is an architectural diagram illustrating a computing system 1000 configured to perform respective functionality in a DSDS system, according to an embodiment of the present invention. In some embodiments, computing system 1000 may be one or more of the computing systems depicted and/or described herein, such as UE, a carrier server, etc. Computing system 1000 includes a bus 1005 or other communication mechanism for communicating information, and processor(s) 1010 coupled to bus 1005 for processing information. Processor(s) 1010 may be any type of general or specific purpose processor, including a Central Processing Unit (CPU), an Application Specific Integrated Circuit (ASIC), a Field Programmable Gate Array (FPGA), a Graphics Processing Unit (GPU), multiple instances thereof, and/or any combination thereof. Processor(s) 1010 may also have multiple processing cores, and at least some of the cores may be configured to perform specific functions. Multi-parallel processing may be used in some embodiments. In certain embodiments, at least one of processor(s) 1010 may be a neuromorphic circuit that includes processing elements that mimic biological neurons. In some embodiments, neuromorphic circuits may not require the typical components of a Von Neumann computing architecture.

Computing system 1000 further includes a memory 1015 for storing information and instructions to be executed by processor(s) 1010. Memory 1015 can be comprised of any combination of random access memory (RAM), read-only memory (ROM), flash memory, cache, static storage such as a magnetic or optical disk, or any other types of non-transitory computer-readable media or combinations thereof. Non-transitory computer-readable media may be any available media that can be accessed by processor(s) 1010 and may include volatile media, non-volatile media, or both. The media may also be removable, non-removable, or both.

Additionally, computing system 1000 includes a communication device 1020, such as a transceiver, to provide access to a communications network via a wireless and/or wired connection. In some embodiments, communication device 1020 may be configured to use Frequency Division Multiple Access (FDMA), Single Carrier FDMA (SC-FDMA), Time Division Multiple Access (TDMA), Code Division Multiple Access (CDMA), Orthogonal Frequency Division Multiplexing (OFDM), Orthogonal Frequency Division Multiple Access (OFDMA), Global System for Mobile (GSM) communications, General Packet Radio Service (GPRS), Universal Mobile Telecommunications System (UMTS), cdma2000, Wideband CDMA (W-CDMA), High-Speed Downlink Packet Access (HSDPA), High-Speed Uplink Packet Access (HSUPA), High-Speed Packet Access (HSPA), Long Term Evolution (LTE), LTE Advanced (LTE-A), 802.11x, Wi-Fi, Zigbee, Ultra-WideBand (UWB), 802.16x, 802.15, Home Node-B (HnB), Bluetooth, Radio Frequency Identification (RFID), Infrared Data Association (IrDA), Near-Field Communications (NFC), fifth generation (5G), New Radio (NR), any combination thereof, and/or any other currently existing or future-implemented communications standard and/or protocol without deviating from the scope of the invention. In some embodiments, communication device 1020 may include one or more antennas that are singular, arrayed, phased, switched, beamforming, beamsteering, a combination thereof, and or any other antenna configuration without deviating from the scope of the invention.

Processor(s) 1010 are further coupled via bus 1005 to a display 1025, such as a plasma display, a Liquid Crystal Display (LCD), a Light Emitting Diode (LED) display, a Field Emission Display (FED), an Organic Light Emitting Diode (OLED) display, a flexible OLED display, a flexible substrate display, a projection display, a 4K display, a high definition display, a Retina® display, an In-Plane Switching (IPS) display, or any other suitable display for displaying information to a user. Display 1025 may be configured as a touch (haptic) display, a three-dimensional (3D) touch display, a multi-input touch display, a multi-touch display, etc. using resistive, capacitive, surface-acoustic wave (SAW) capacitive, infrared, optical imaging, dispersive signal technology, acoustic pulse recognition, frustrated total internal reflection, etc. Any suitable display device and haptic I/O may be used without deviating from the scope of the invention.

A keyboard 1030 and a cursor control device 1035, such as a computer mouse, a touchpad, etc., are further coupled to bus 1005 to enable a user to interface with computing system 1000. However, in certain embodiments, a physical keyboard and mouse may not be present, and the user may interact with the device solely through display 1025 and/or a touchpad (not shown). Any type and combination of input devices may be used as a matter of design choice. In certain embodiments, no physical input device and/or display is present. For instance, the user may interact with computing system 1000 remotely via another computing system in communication therewith, or computing system 1000 may operate autonomously.

Memory 1015 stores software modules that provide functionality when executed by processor(s) 1010. The modules include an operating system 1040 for computing system 1000. The modules further include a DSDS module 1045 that is configured to perform all or part of the processes described herein or derivatives thereof. Computing system 1000 may include one or more additional functional modules 1050 that include additional functionality.

One skilled in the art will appreciate that a “computing system” could be embodied as a server, an embedded computing system, a personal computer, a console, a personal digital assistant (PDA), a cell phone, a tablet computing device, a quantum computing system, or any other suitable computing device, or combination of devices without deviating from the scope of the invention. Presenting the above-described functions as being performed by a “system” is not intended to limit the scope of the present invention in any way, but is intended to provide one example of the many embodiments of the present invention. Indeed, methods, systems, and apparatuses disclosed herein may be implemented in localized and distributed forms consistent with computing technology, including cloud computing systems. The computing system could be part of or otherwise accessible by a local area network (LAN), a mobile communications network, a satellite communications network, the Internet, a public or private cloud, a hybrid cloud, a server farm, any combination thereof, etc. Any localized or distributed architecture may be used without deviating from the scope of the invention.

It should be noted that some of the system features described in this specification have been presented as modules, in order to more particularly emphasize their implementation independence. For example, a module may be implemented as a hardware circuit comprising custom very large scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, include one or more physical or logical blocks of computer instructions that may, for instance, be organized as an object, procedure, or function. Nevertheless, the executables of an identified module need not be physically located together, but may include disparate instructions stored in different locations that, when joined logically together, comprise the module and achieve the stated purpose for the module. Further, modules may be stored on a computer-readable medium, which may be, for instance, a hard disk drive, flash device, RAM, tape, and/or any other such non-transitory computer-readable medium used to store data without deviating from the scope of the invention.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

The process steps performed in FIGS. 3-7 may be performed by computer program(s), encoding instructions for the processor(s) to perform at least part of the process(es) described in FIGS. 3-7, in accordance with embodiments of the present invention. The computer program(s) may be embodied on non-transitory computer-readable media. The computer-readable media may be, but are not limited to, a hard disk drive, a flash device, RAM, a tape, and/or any other such medium or combination of media used to store data. The computer program(s) may include encoded instructions for controlling processor(s) of computing system(s) (e.g., processor(s) 1010 of computing system 1000 of FIG. 10) to implement all or part of the process steps described in FIGS. 3-7, which may also be stored on the computer-readable medium.

The computer program(s) can be implemented in hardware, software, or a hybrid implementation. The computer program(s) can be composed of modules that are in operative communication with one another, and which are designed to pass information or instructions to display. The computer program(s) can be configured to operate on a general purpose computer, an ASIC, or any other suitable device.

It will be readily understood that the components of various embodiments of the present invention, as generally described and illustrated in the figures herein, may be arranged and designed in a wide variety of different configurations. Thus, the detailed description of the embodiments of the present invention, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, reference throughout this specification to “certain embodiments,” “some embodiments,” or similar language means that a particular feature, structure, or characteristic described in connection with the embodiment is included in at least one embodiment of the present invention. Thus, appearances of the phrases “in certain embodiments,” “in some embodiment,” “in other embodiments,” or similar language throughout this specification do not necessarily all refer to the same group of embodiments and the described features, structures, or characteristics may be combined in any suitable manner in one or more embodiments.

It should be noted that reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1. A non-transitory computer-readable medium of a dual subscriber identity module (SIM) dual standby (DSDS)-enabled device storing a computer program, the computer program configured to cause at least one processor to:
detect that a carrier network associated with a secondary SIM is available;
bind a framework associated with the secondary SIM to a carrier application that provides a carrier configuration service; and
configure the secondary SIM via the carrier application, wherein
the configuration of the secondary SIM comprises grouping subscriptions of a primary SIM and the secondary SIM and making the secondary SIM opportunistic.

2. The non-transitory computer-readable medium of claim 1, wherein
the DSDS device comprises the primary SIM, and
the primary SIM and the secondary SIM are both physical SIMs (pSIMs), the primary SIM and the secondary SIM are both embedded SIMS (eSIMs), or one of the primary SIM and the secondary SIM is a pSIM and the other of the primary SIM and the secondary SIM is an eSIM.

3. The non-transitory computer-readable medium of claim 2, wherein
the primary SIM is used for voice traffic and Internet Protocol (IP) multimedia subsystem (IMS) traffic, and
the secondary SIM is used for data traffic.

4. The non-transitory computer-readable medium of claim 1, wherein the computer program is further configured to cause the at least one processor to:
display a single SIM icon, a single network signal indicator, or both, for both the primary SIM and the secondary SIM.

5. The non-transitory computer-readable medium of claim 4, wherein the computer program is further configured to cause the at least one processor to:
prevent a user of the DSDS device from accessing settings pertaining to the secondary SIM.

6. The non-transitory computer-readable medium of claim 1, wherein the computer program is further configured to cause the at least one processor to:
return a name of a brand and a carrier certificate array; and
add access point names (APNs) for the brand.

7. The non-transitory computer-readable medium of claim 1, wherein the secondary SIM is an embedded SIM (eSIM) and the computer program is further configured to cause the at least one processor to:
perform a DSDS configuration, comprising:
retrieving an activation code,
downloading the eSIM, and
making the eSIM preferred for data.

8. The non-transitory computer-readable medium of claim 1, wherein the computer program is further configured to cause the at least one processor to:
monitor a signal-to-noise ratio (SNR) of a radio of the secondary SIM; and
drop a carrier network associated with the secondary SIM responsive to the SNR of the radio of the secondary SIM falling below a first value.

9. The non-transitory computer-readable medium of claim 8, wherein the computer program is further configured to cause the at least one processor to:
add the carrier network associated with the secondary SIM;
check the SNR of the radio of the secondary SIM; and
use the carrier network responsive to the SNR of the radio of the secondary SIM being at least a second value.

10. The non-transitory computer-readable medium of claim 1, wherein the computer program is further configured to cause the at least one processor to:
enable DSDS responsive to presence of an embedded universal integrated circuit card (eUICC).

11. The non-transitory computer-readable medium of claim 1, wherein the carrier application leverages application programming interfaces (APIs) of the carrier to group the subscriptions of the primary SIM and the secondary SIM and to make the secondary SIM opportunistic.

12. The non-transitory computer-readable medium of claim 1, wherein, responsive to a user removing the secondary SIM, the computer program is further configured to cause the at least one processor to:
detect a SIM state absent event for the secondary SIM; and
disable the subscription of the secondary SIM.

13. The non-transitory computer-readable medium of claim 12, wherein, responsive to a user reinserting the secondary SIM, the computer program is further configured to cause the at least one processor to:
detect a SIM state loaded event for the secondary SIM;
enable the subscription of the secondary SIM; and
make the secondary SIM a default for a data subscription.

14. The non-transitory computer-readable medium of claim 1, wherein
the DSDS device comprises at least one additional SIM in addition to the primary SIM and the secondary SIM,
the at least one additional SIM is not visible to a user via the DSDS device.

15. A computer-implemented method for providing dual subscriber identity module (SIM) dual standby (DSDS), comprising:
detecting that a carrier network associated with a secondary SIM is available, by a DSDS device;
binding a framework associated with the secondary SIM to a carrier application that provides a carrier configuration service, by the DSDS device; and
configuring the secondary SIM via the carrier application, by the DSDS device;
displaying a single SIM icon, a single network signal indicator, or both, for both a primary SIM and the secondary SIM, by the DSDS device; and
preventing a user of the DSDS device from accessing settings pertaining to the secondary SIM, by the DSDS device.

16. The computer-implemented method of claim 15, wherein the configuration of the secondary SIM comprises grouping subscriptions of the primary SIM and the secondary SIM and making the secondary SIM opportunistic.

17. The computer-implemented method of claim 15, wherein
the DSDS device comprises the primary SIM, and
the primary SIM and the secondary SIM are both physical SIMs (pSIMs), the primary SIM and the secondary SIM are both embedded SIMS (eSIMs), or one of the primary SIM and the secondary SIM is a pSIM and the other of the primary SIM and the secondary SIM is an eSIM.

18. The computer-implemented method of claim 15, further comprising:
monitoring a signal-to-noise ratio (SNR) of a radio of the secondary SIM, by the DSDS device; and
dropping a carrier network associated with the secondary SIM responsive to the SNR of the radio falling below a first value, by the DSDS device.

19. The computer-implemented method of claim 18, further comprising:
adding the carrier network associated with the secondary SIM, by the DSDS device;
checking the SNR of the radio of the secondary SIM, by the DSDS device; and
using the carrier network responsive to the SNR of the radio of the secondary SIM being at least a second value, by the DSDS device.

20. A computing system, comprising:
memory storing computer program instructions; and
at least one processor configured to execute the computer program instructions, wherein the computer program instructions are configured to cause the at least one processor to:
detect that a carrier network associated with a secondary subscriber identity module (SIM) is available;
bind a framework associated with the secondary SIM to a carrier application that provides a carrier configuration service; and
configure the secondary SIM via the carrier application, wherein
the computing system comprises at least one additional SIM in addition to the primary SIM and the secondary SIM, and
the at least one additional SIM is not visible to a user via the computing system.
